(19) United States
(12) Patent Application Publication
(10) Pub. No.: US 2007/0224991 A1
(43) Pub. Date: Sep. 27, 2007

(54) Apparatus and method for processing handover complete signal in a multi-hop relay broadband wireless access communications system

(75) Inventors: Hyun-Jeong Kang, Seoul (KR); Jae-Weon Cho, Suwon-si (KR); Sung-Jin Lee, Seoul (KR); Mi-Hyun Lee, Seoul (KR); Pan-Yuh Joo, Seoul (KR); Joon-Young Choi, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,700

(22) Filed: Mar. 6, 2007

(30) Foreign Application Priority Data
Mar. 6, 2006 (KR) 2006-0020846

(51) Int. Cl. H04Q 7/20

(52) U.S. Cl. 455/436

(57) ABSTRACT

An apparatus and method for processing a handover complete signal in a multi-hop relay BWA communication system are provided in which a BS detects a source node of a Mobile Station (MS), when the MS completes network reentry, and transmits a handover complete message for the MS to the source node.

### PRIORITY

This application claims priority under 35 U.S.C. § 119 to an application filed in the Korean Intellectual Property Office on Mar. 6, 2006 and assigned Serial No. 2006-20846, the contents of which are incorporated herein by reference.

### BACKGROUND OF THE INVENTION

1. Field of the Invention

The present invention relates generally to a multi-hop relay Broadband Wireless Access (BWA) communication system, and in particular; to an apparatus and method for processing a handover complete signal.

2. Description of the Related Art

Provisioning of services with diverse Quality of Service (QoS) requirements at about 100 Mbps to users is an active study area for the future-generation 4^{th} Generation (4G) communication system. Particularly, active research is being conducted on provisioning of high-speed service by ensuring mobility and QoS to a BWA communication system such as Wireless Local Area Network (WLAN) and Wireless Metropolitan Area Network (WMAN). Such major examples are Institute of Electrical and Electronics Engineers (IEEE) 802.16d and IEEE 802.16e.

The IEEE 802.16d and IEEE 802.16e communication systems adopt Orthogonal Frequency Division Multiplexing/Orthogonal Frequency Division Multiple Access (OFDM/OFDMA) for physical channels. IEEE 802.16d considers only a single-cell structure with no regard to mobility of Subscriber Stations (SSs). In contrast, IEEE 802.16e supports the SS's mobility to the IEEE 802.16d communication system. Hereinafter, a mobile SS is called an MS.

FIG. 1 illustrates the configuration of a typical IEEE 802.16e communication system.

Referring to FIG. 1, the IEEE 802.16e communication system is configured in a multi-cell structure. Specifically, it includes cells 100 and 150, Base Stations (BSs) 110 and 140 for managing the cells 100 and 150, respectively, and a plurality of MSs 111, 113, 130, 151 and 153. Signaling is carried out in OFDM/OFDMA between the BSs 110 and 140 and the MSs 111, 113, 130, 151 and 153. Among the MSs 111, 113, 130, 151 and 153, the MS 130 is located in a cell boundary area between the cells 100 and 150, i.e. in a handover region. When the MS 130 moves to the cell 150 managed by the BS 140 during signal transmission/reception to/from the BS 110, the serving BS of the MS 130 changes from the BS 110 to the BS 140.

Since signaling is carried out between an MS and a fixed BS via a direct link as illustrated in FIG. 1, a highly reliable radio communication link can be established between them in the typical IEEE 802.16e communication system. However, due to the fixedness of BSs, a wireless network cannot be flexibly configured. As a result, the IEEE 802.16e communication system is not effective in efficiently providing communication services under a radio environment experiencing a fluctuating traffic distribution and a significant change in the number of required calls.

To avoid the problem, a multi-hop relay data transmission scheme using fixed Relay Stations (RSs), mobile RSs or general MSs is applied to conventional cellular wireless communication systems such as IEEE 802.16e. The multi-hop relay wireless communication system can advantageously reconfigure a network rapidly according to a communication environmental change and enables efficient operation of the entire wireless network. It can expand cell coverage and increase system capacity. When the channel status between a BS and an MS is poor, an RS is installed between them so that the resulting establishment of a multi-hop relay through the RS renders a better radio channel available to the MS. With the use of the multi-hop relay scheme at a cell boundary where the channel status is poor, high-speed data channels become available and the cell coverage is expanded.

FIG. 2 illustrates the configuration of a multi-hop relay BWA communication system configured to expand the service coverage of a BS.

Referring to FIG. 2, the multi-hop relay BWA communication system, which is configured in a multi-cell structure, includes cells 200 and 240, BSs 210 and 250 for managing the cells 200 and 240, respectively, a plurality of MSs 211 and 213 within the coverage area of the cell 200, a plurality of MSs 221 and 223 managed by the BS 210 but located in an area 230 outside the cell 200, an RS 220 for providing a multi-hop relay path between the BS 210 and the MSs 221 and 223 within the area 230, a plurality of MSs 251, 253 and 255 within the coverage area of the cell 240, a plurality of MSs 261 and 263 managed by the BS 250 but in an area 270 outside the cell 240, and an RS 260 for providing a multi-hop relay path between the BS 250 and the MSs 261 and 263 within the area 270. Signal transmission/reception is carried out in OFDM/OFDMA among the BSs 210 and 250, the RSs 220 and 260, and the MSs 211, 213, 221, 223, 251, 253, 255, 261, and 263.

FIG. 3 illustrates the configuration of a multi-hop relay BWA communication system configured to increase system capacity.

Referring to FIG. 3, the multi-hop relay wireless communication system includes a BS 310, a plurality of MSs 311, 313, 321, 323, 331 and 333, and RSs 320 and 330 for providing multi-hop relay paths between the BS 310 and the MSs. Signal transmission/reception is carried out in OFDM/OFDMA among the BS 310, the RSs 320 and 330, and the MSs 311, 313, 321, 323, 331 and 333. The BS 310 manages a cell 300, and the MSs 311, 313, 321, 323, 331 and 333 within the coverage area of the cell 300 and the RSs 320 and 330 can communicate directly with the BS 310.

Yet, the direct links between the BS 310 and the MSs 321, 323, 331 and 333 at the boundary of the cell 300 may have low Signal-to-Noise Ratios (SNRs). Therefore, the RSs 320 and 330 provide high-speed data transmission paths to the MSs 321, 323, 331 and 333, thereby increasing their effective data rates and system capacity.

In the multi-hop relay BWA communication systems illustrated in FIGS. 2 and 3, the RSs 220, 260, 320 and 330 are infrastructure RSs installed by a service provider and thus known to the BSs 210, 250 and 310, or client RSs that SSs or MSs serve. The RSs 220, 260, 320 and 330 may also be fixed, nomadic (e.g. laptop) or mobile (e.g. MSs).

In the above-described multi-hop relay wireless communication system, as an MS moves from one BS or RS to another BS or RS during communications with the old serving BS or RS (i.e. source BS or RS), a handover can be triggered. The MS performs network reentry with the target node (i.e. target BS or RS), thereby completing the handover. Then the MS continues on-going communications through the target node. During the handover procedure to the target node, the source node (i.e. source BS or RS) can preserve information about the MS to be used for the network reentry between the MS and the target node. After the handover is completed, the source node does not need to preserve the MS information. Accordingly, there exists a need for a signaling procedure to notify the source node of the handover completion.

### SUMMARY OF THE INVENTION

An aspect of the present invention is to substantially solve at least the above problems and/or disadvantages and to provide at least the advantages below. Accordingly, an aspect of the present invention is to provide an apparatus and method for processing a handover complete signal in a multi-hop relay BWA communication system.

Another aspect of the present invention is to provide an apparatus and method for processing a handover complete signal between a source BS or RS and a target BS or RS in a multi-hop relay BWA communication system.

In accordance with the present invention, there is provided a method of a BS for processing a handover complete signal in a multi-hop relay BWA communication system, in which when an MS completes network reentry, a source node of an MS is detected and a handover complete message for the MS is transmitted to the source node, if the source node is detected.

In accordance with the present invention, there is provided a method of a BS for processing a handover complete signal in a multi-hop relay BWA communication system, in which upon receipt of a handover complete message for a Mobile Station (MS) that has completed a handover, it is determined whether the handover complete message is from a neighbor BS, information about the MS is deleted if the handover complete message is from the neighbor BS, and the MS information is preserved if the handover complete message is not from the neighbor BS.

In accordance with the present invention, there is provided a method of an RS for processing a handover complete signal in a multi-hop relay BWA communication system, in which when an MS completes network reentry to the RS, a handover complete message for the MS is generated and transmitted to a BS.

In accordance with the present invention, there is provided a method of an RS for processing a handover complete signal in a multi-hop relay BWA communication system, in which upon receipt of a handover indication message from an MS, it is checked whether the RS has determined to preserve information about the MS and if the RS has determined to preserve the MS information, the MS information is preserved for an MS information preservation time period.

In accordance with the present invention, there is provided an apparatus for processing a handover complete signal in a multi-hop relay BWA communication system, in which when an MS completes network reentry to a BS, the BS transmits a handover complete message for the MS to at least one of a source node of the MS or a BS of the source node, upon receipt of a handover complete message from a neighbor BS, the BS deletes information about an MS that has completed a handover associated with the handover complete message, and upon receipt of a handover complete message from an RS managed by the BS, the BS preserves information about an MS that has completed a handover associated with the handover complete message, and an RS generates a handover complete message and transmits the handover complete message to a BS, if the MS completes network reentry to the RS, and upon receipt of a handover indication message from an MS, the RS checks whether the RS has determined to preserve information about the MS and preserves the MS information for an MS information preservation time period, if the RS has determined to preserve the MS information.

In accordance with the present invention, there is provided a method of an RS for processing a handover complete signal in a multi-hop relay BWA communication system, in which data is relayed between an MS and a BS, and upon receipt of a handover complete message for the MS from the BS, information about the MS is deleted.

In accordance with the present invention, there is provided an apparatus for processing a handover complete signal in a multi-hop relay BWA communication system, in which a BS transmits a handover complete message for an MS to at least one of a source node of the MS and a BS of the source node, when the MS completes network reentry to the BS and upon receipt of a handover complete message from a neighbor BS, deletes information about an MS that has completed a handover associated with the handover complete message, and an RS for relaying data between an MS and the BS and deleting information about the MS, upon receipt of a handover complete message for the MS from the BS.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a conventional IEEE 802.16e communication system;

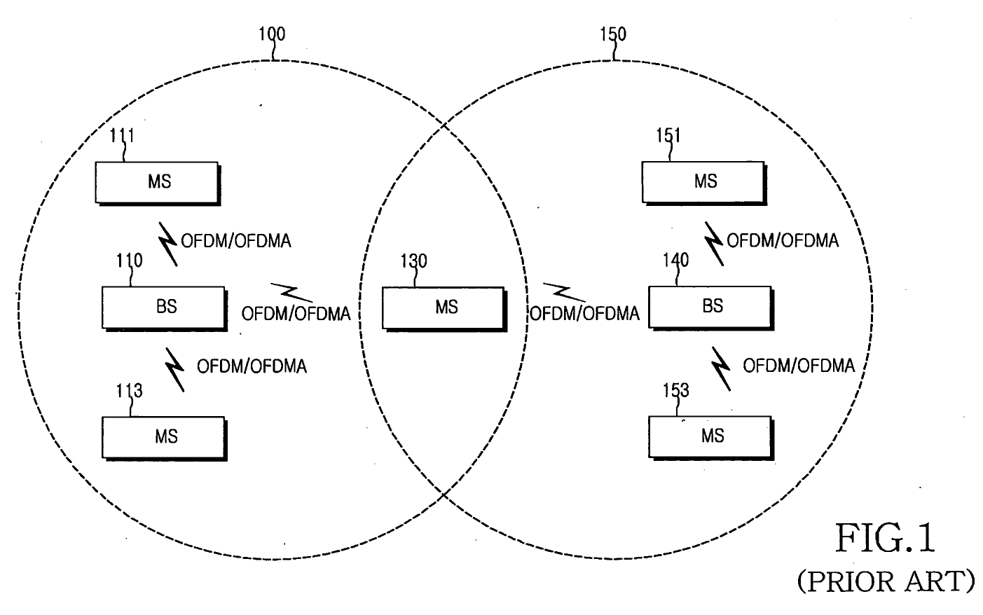

FIG. 2 illustrates the configuration of a conventional multi-hop relay BWA communication system configured to expand the service coverage of a BS;

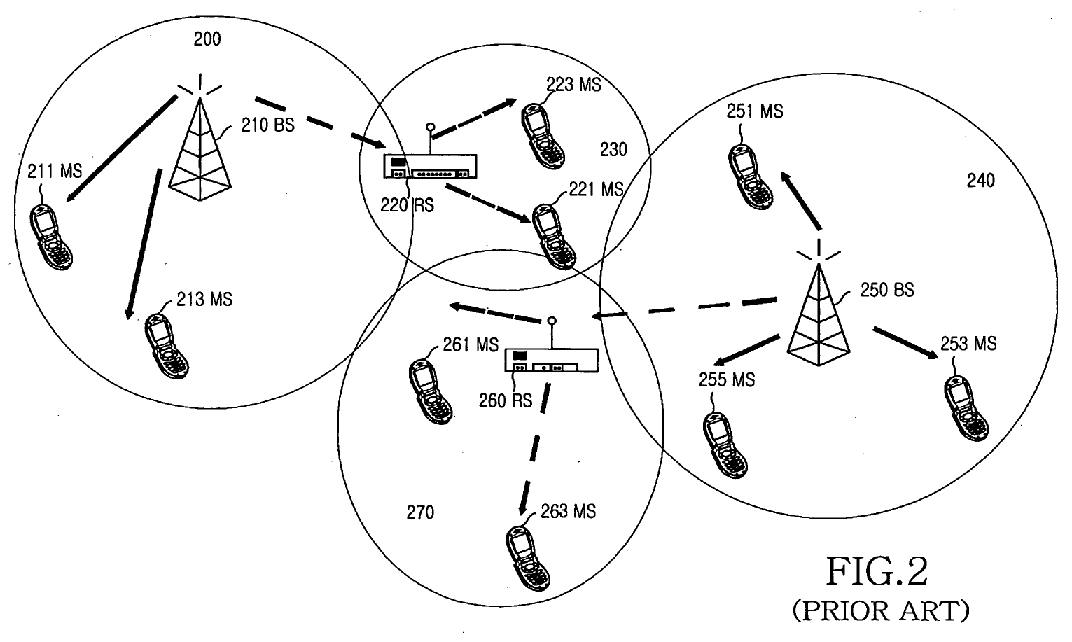

FIG. 3 illustrates the configuration of a conventional multi-hop relay BWA communication system configured to increase system capacity;

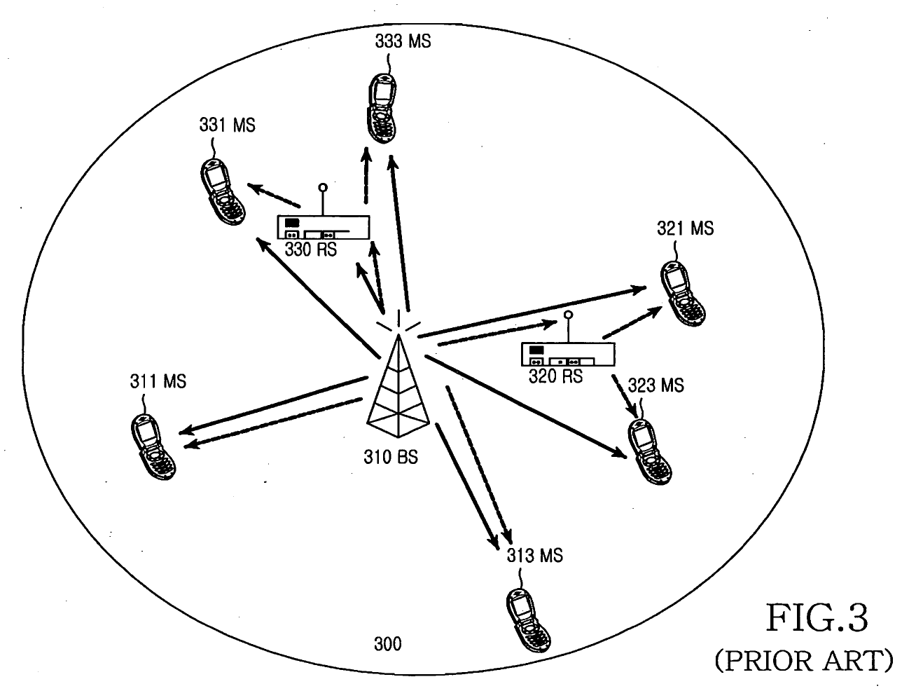

FIG. 4 illustrates an operation of a target BS for processing a handover complete message in a multi-hop relay BWA communication system according to the present invention;

FIG. 5 illustrates an operation of a target RS for processing a handover complete message in the multi-hop relay BWA communication system according to the present invention;

FIG. 6 illustrates an operation of a BS that receives the handover complete message in the multi-hop relay BWA communication system according to the present invention;

FIG. 7 illustrates an operation of a source RS for processing a handover complete message in the multi-hop relay BWA communication system according to the present invention;

FIG. 8 is a block diagram of a BS (or an RS) according to the present invention; and

FIG. 9 illustrates an operation of the source RS for processing a handover complete message in the multi-hop relay BWA communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides an apparatus and method for processing a handover complete signal in a multi-hop relay BWA communication system. The multi-hop relay BWA communication system is, for example, an OFDM/OFDMA communication system that can support high-speed data transmission and the mobility of MSs in a multi-cell structure by sending physical channel signals on a plurality of subcarriers.

While the following description is made in the context of the BWA communication system, it is to be appreciated that the present invention is also applicable to a multi-hop relay cellular communication system.

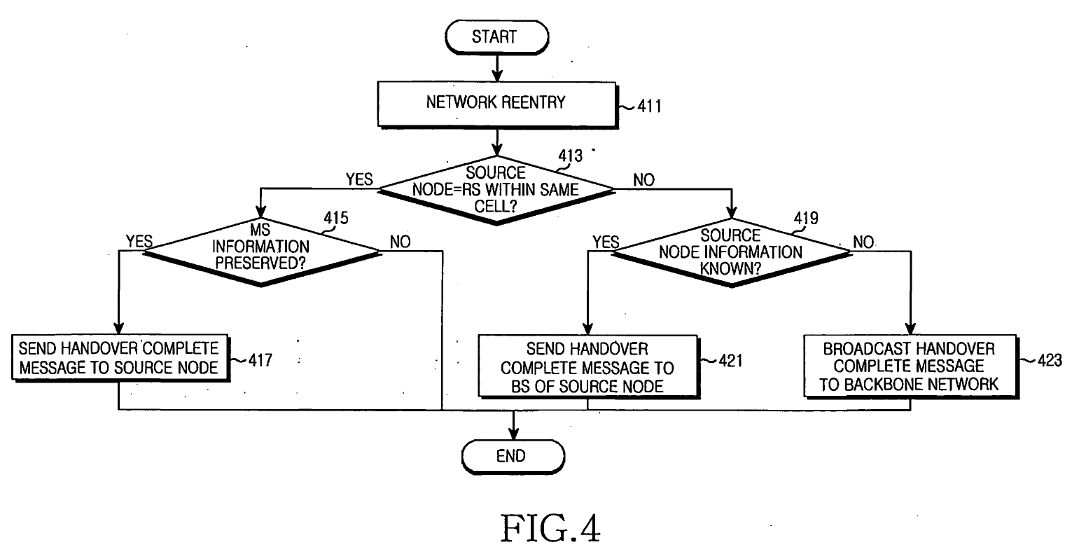

FIG. 4 illustrates an operation of a target BS for processing a handover complete message in a multi-hop relay BWA communication system according to the present invention.

Referring to FIG. 4, the target BS completes network reentry of an MS that has moved out of a source node, thereby completing a handover procedure for the MS in step 411. In step 413, the target BS determines whether the source node is an RS within its coverage area.

If the source node is an RS within the coverage area of the target BS, the target BS determines whether the source RS preserves information about the MS in step 415. If the source RS has the MS information, the target BS sends a handover complete message to the source RS in step 417. Then the target BS ends the handover complete message process. However, if it determines that the source RS does not preserve the MS information, the target BS ends the handover complete message process.

The handover complete message has the following format.

TABLE 1

| Syntax | Size (bits) | Notes |
|---|---|---|
| Handover complete message | | |
| format( ) { | | |
| MS ID | variable | MS's identifier |
| } | | |

Referring to Table 1, the handover complete message identifies an MS that has completed handover. If a plurality of MSs managed by the source node has completed handover, the handover complete message may identify the MSs.

If the source node is not an RS within the coverage area of the target BS in step 413, the target BS is aware that the source node is in the coverage area of another BS and determines whether it has knowledge of the source node in step 419. The source node may be a neighbor BS or an RS managed by the neighbor BS. In the latter case, the target BS may not find out the BS that covers the source RS.

If the target BS has knowledge of the source node, it sends a handover complete message to a neighbor BS that manages the source node in step 421 and ends the handover complete message process. This handover complete message is a backbone message including the same MS information as the handover complete message illustrated in Table 1. It may have a different configuration from that of the handover complete message illustrated in Table 1.

If the target BS has no knowledge of the source node in step 419, it broadcasts the handover complete message including the MS information to a backbone network in step 423. A neighbor BS that covers the MS indicated by the handover complete message may receive the message and process it. Alternatively, if there is a system that manages the entire network, the target BS acquires information about a neighbor BS managing the source node from the system and sends the handover complete message to the neighbor BS, instead of broadcasting the handover complete message to the backbone network. Then the target BS ends the handover complete message process.

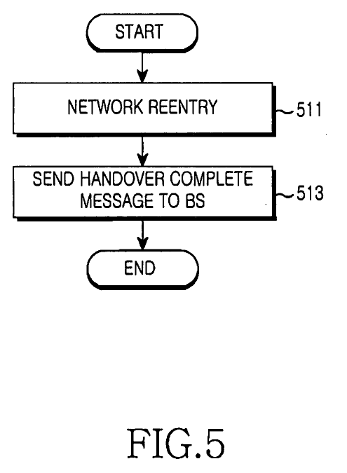

FIG. 5 illustrates an operation of a target RS for processing a handover complete message in the multi-hop relay BWA communication system according to the present invention.

Referring to FIG. 5, the target RS completes network reentry of an MS that has moved out of a source node, thereby completing a handover procedure for the MS in step 511. In step 513, the target RS sends a handover complete message having the configuration illustrated in Table 1 to a BS managing the target RS and ends the handover complete message process by a normal communication procedure with the MS.

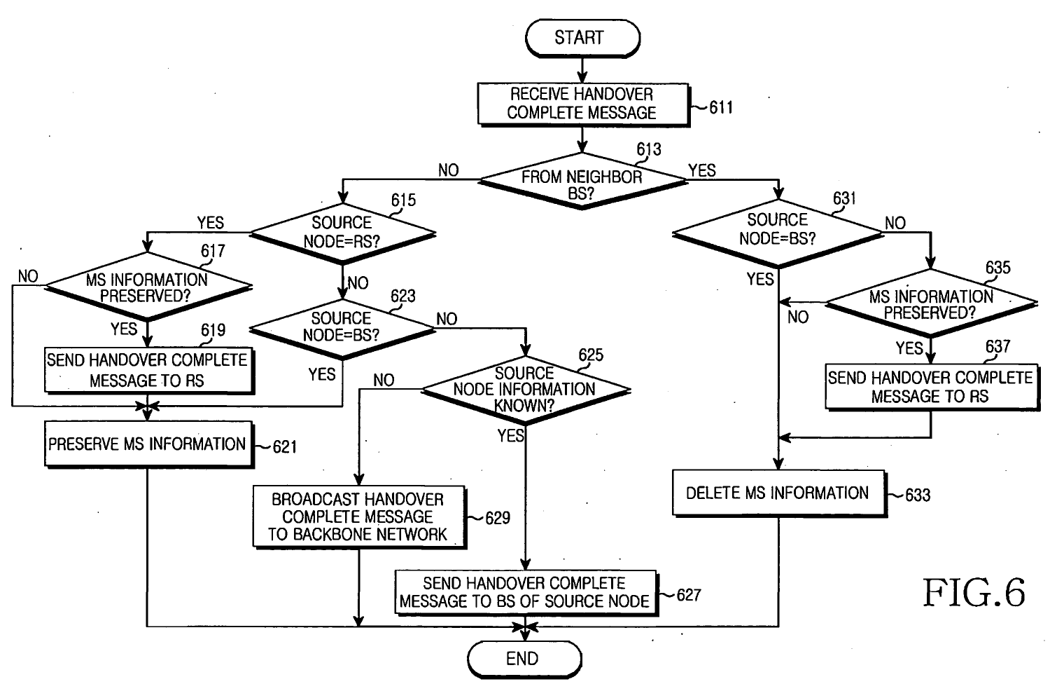

FIG. 6 illustrates an operation of a BS that receives the handover complete message in the multi-hop relay BWA communication system according to the present invention.

Referring to FIG. 6, the BS receives the handover complete message in step 611 and determines whether the handover complete message is from a neighbor BS in step 613. If an RS managed by the BS has sent the handover complete message, i.e. if a handover complete message having the configuration, illustrated in Table 1 has been received from an RS covered by the BS, the BS determines whether the source node of an MS indicated by the handover complete message is another RS managed by the BS in step 615.

If another RS managed by the BS is the source node of the MS, the BS determines whether the source RS preserves information about the MS in step 617. If the source RS does, the BS sends the handover complete message illustrated in Table 1 to the source RS so that the source RS deletes the MS information in step 619 and the BS manages the MS information as the serving BS of the MS in step 621. If the source RS does not have the MS information, the BS jumps to step 621 in which the BS manages the MS information as the serving BS of the MS. Then, the BS ends processing the received handover complete message,

If the source node of the MS is not another RS within the coverage area of the BS in step 615, the BS determines whether the source node is the BS itself in step 623. If the source node is the BS, the BS manages the MS information as the serving BS of the MS in step 621.

If the source node is not the BS, the BS determines that the MS has moved from the coverage area of a neighbor BS to its coverage area and determines whether it has knowledge of the source node of the MS in step 625.

If the BS has knowledge of the source node, it sends a handover complete message to the neighbor BS managing the source node in step 627. The handover complete message may be a backbone message having a different configuration from that illustrated in Table 1. It may include the same MS information as included in the handover complete message of Table 1.

If the BS has no knowledge of the source node in step 625, it broadcasts a handover complete message having the MS information to the backbone network in step 629. A neighbor BS managing the MS indicated by the handover complete message may receive the message and process it. Alternatively, if there is a system that manages the entire network, the target BS acquires information about the neighbor BS managing the source node from the system and sends the handover complete message to the neighbor BS, instead of broadcasting the handover complete message to the backbone network. Then the BS ends processing the handover complete message.

If the handover complete message has been received from the neighbor BS in step 613, the BS determines whether the source node of the MS is the BS itself in step 631. The handover complete message may be a backbone message having a different configuration from that illustrated in Table 1. It may include the same MS information as included in the handover complete message of Table 1.

If it determines that the source node of the MS is an RS managed by the BS in step 631, the BS determines whether the RS preserves the MS information in step 635. If the RS does, the BS sends a handover complete message having the configuration illustrated in Table 1 to the RS so that the RS deletes the MS information in step 637. In step 633, the BS deletes the MS information that it has preserved. If the RS does not preserve the MS information in step 635, the BS deletes the MS information that it has, considering that the MS has completed the handover to the neighbor BS in step 633. Then the BS ends the handover complete message process.

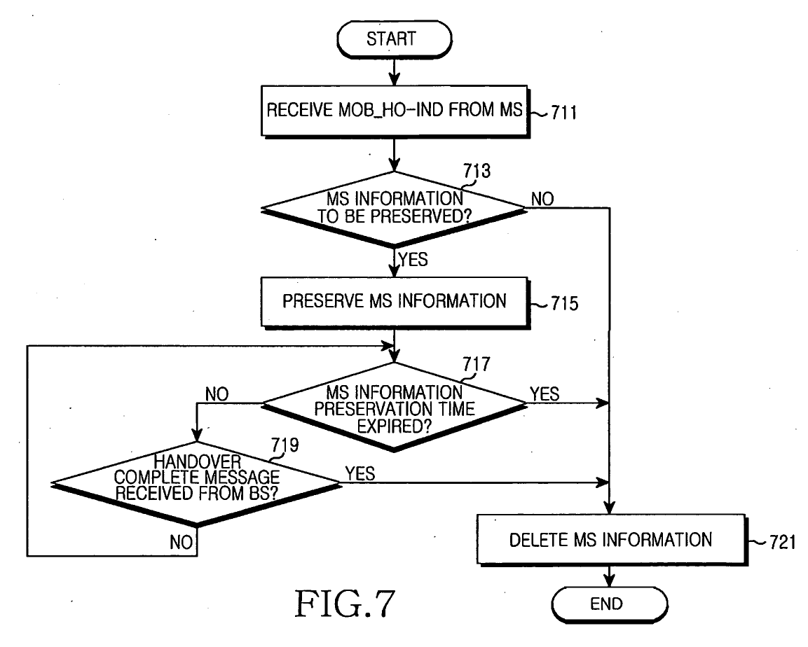

FIG. 7 illustrates an operation of a source RS for processing a handover complete message in the multi-hop relay BWA communication system according to the present invention.

Referring to FIG. 7, the source RS receives a Mobile HandOver Indication (MOB_HO-IND) message indicating a handover from an MS that the source RS serves in step 711. In step 713, the source RS determines whether to preserve information about the MS for a set time. The determination can be made by a signaling procedure between the source RS and a serving BS of the RS and the MS during a handover negotiation. The BS makes a final decision as to whether and how long the MS information is to be preserved. An indication of whether the MS information is to be preserved is set in a resource retain flag of handover control messages exchanged with the MS during the handover negotiation. If it determines to preserve the MS information for the MS information preservation time, the RS sets the resource retain flag to 1 and sends a handover control message including the resource retain flag and the MS information preservation time to the MS. The exchange of the handover control messages including the MS information preservation indication is beyond the scope of the present invention and will not be discussed herein.

If it determines to preserve the MS information in step 713, the source RS preserves the MS information for the MS information preservation time in step 715 and monitors expiration of the MS information preservation time in step 717. If the MS information preservation time has not expired, the source RS monitors reception of a handover complete message having the configuration of Table 1 from the BS managing the source RS in step 719. If the handover complete message has not been received, the source RS monitors expiration of the MS information preservation in step 717.

However, if the source RS determines not to preserve the MS information in step 713, or if the MS information preservation time has expired in step 717 or the source RS has received the handover complete message from the BS managing the source RS in step 719, the source RS deletes the MS information in step 721 and then ends the algorithm of the present invention.

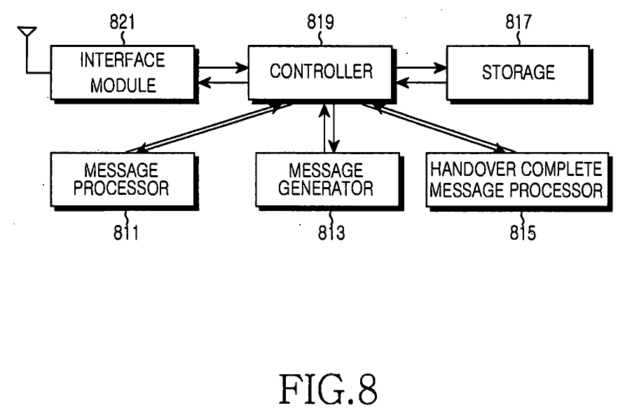

FIG. 8 is a block diagram of a BS (or an RS) according to the present invention. The BS and the RS have the same interface module, i.e. communication module. Since they are configured in the same manner, the operations of the BS and the RS will be described below, with regard to a single apparatus including a message processor 811, a message generator 813, a handover complete message processor 815, a storage 817, a controller 819 and an interface module 821.

As to the configuration of the RS, referring to FIG. 8, the controller 819 provides overall control to the RS. For example, the controller 819 processes and controls voice and data communication. The controller 819 processes a handover complete message indicating completion of an MS's handover according to the present invention. The controller 819 provides a control message received from the MS or the BS to the message processor 811 and provides a message to be sent to the MS or the BS received from the message generator 813 to the interface module 821 in the present invention.

The message processor 811 analyzes a control message received from the MS or the BS and notifies the controller 819 of the analysis result. According to the present invention, upon receipt of a handover complete message configured to have information about an MS that has completed a handover as illustrated in Table 1 from the BS, the message processor 811 extracts control information from the message. The controller 819 operates in accordance with the control information received from the message processor 811.

The message generator 813 generates a message to be sent to the BS or an MS managed by the RS under the control of the controller 819 and provides it to the controller 819. According to the present invention, the message generator 813 generates a handover complete message including information about an MS that has completed a handover as illustrated in Table 1 and provides it to the interface module 821 through the controller 819.

The handover complete message processor 815 operates to configure the handover complete message of Table 1 to provide information about the MS that has completed the handover to the RS or to delete information about the MS indicated by the handover complete message of Table 1 under the control of the controller 819.

The storage 817 stores programs for providing overall control to the RS and temporary data generated during execution of the programs. That is, the storage 817 stores data and control information to be sent to the MS or the BS.

The interface module 821 is a communication module for communicating with the MS or the BS, including a Radio Frequency (RF) processor and a baseband processor. The RF processor downconverts an RF signal received through an antenna to a baseband signal and provides it to the baseband processor. It also upconverts a baseband signal received from the baseband processor to an RF signal for transmission in the air and then sends the RF signal through the antenna. For example, in a BWA scheme, the baseband processor acquires the original information data (i.e. traffic or a control message) from the signal received from the RF processor by Fast Fourier Transform (FFT) and channel decoding and provides the original information data to the controller 819. Conversely, the baseband processor processes information data received from the controller 819 by channel encoding and Inverse Fast Fourier Transform (IFFT) and provides the processed signal to the RF processor.

As to the configuration of the BS, referring to FIG. 8, the controller 819 provides overall control to the BS. For example, the controller 819 processes and controls voice and data communication. In addition, the controller 819 processes a handover complete message indicating completion of an MS's handover according to the present invention. The controller 819 provides a control message received from the MS or the RS to the message processor 811 and provides a message to be sent to the MS or the RS received from the message generator 813 to the interface module 821 in the present invention.

The message processor 811 analyzes a control message received from the MS or the RS and notifies the controller 819 of the analysis result. According to the present invention, upon receipt of a handover complete message configured to have information about an MS that has completed a handover as illustrated in Table 1 from the RS, or upon receipt of a handover complete message including information about an MS that has completed a handover from a neighbor BS, the message processor 811 extracts control information from the message. The controller 819 operates in accordance with the control information received from the message processor 811.

The message generator 813 generates a message to be sent to the RS or the MS under the control of the controller 819 and provides it to the controller 819. According to the present invention, the message generator 813 generates a handover complete message having the configuration illustrated in Table 1 to provide the RS with information about an MS that has completed a handover or a handover complete message to provide the BS with information about an MS that has completed a handover, and provides it to the interface module 821 through the controller 819.

The handover complete message processor 815 identifies the source node of the MS and sends a handover complete message under the control of the controller 819. Also, the handover complete message processor 815 performs a necessary operation to process a handover complete message received from the target node of the MS that has completed the handover.

The storage 817 stores programs for providing overall control to the BS and temporary data generated during execution of the programs. That is, the storage 817 stores data and control information to be sent to the MS or the RS.

The interface module 821 is for communicating with the MS or the RS, including the RF processor and the baseband processor. The RF processor downconverts an RF signal received through an antenna to a baseband signal and provides it to the baseband processor. It also upconverts a baseband signal received from the baseband processor to an RF signal for transmission in the air and then sends the RF signal through the antenna. For example, in a BWA scheme, the baseband processor acquires the original information data (i.e. traffic or a control message) from the signal received from the RF processor by FFT and channel decoding and provides the original information data to the controller 819. Conversely, the baseband processor processes information data received from the controller 819 by channel encoding and IFFT and provides the processed signal to the RF processor.

In the above-described RS or BS configuration, the controller 819 controls and performs the functionalities of the message processor 811, the message generator 813 and the handover complete message processor 815.

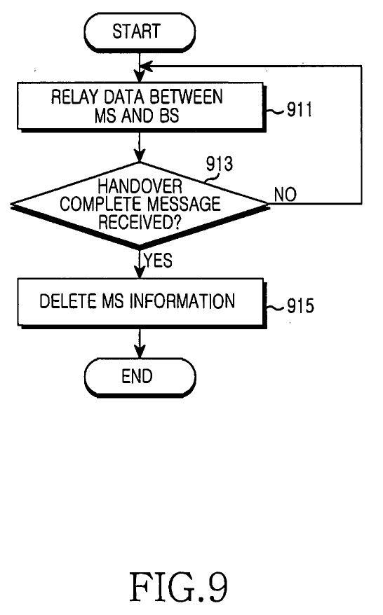

FIG. 9 illustrates an operation of the source RS for processing a handover complete message in the multi-hop relay BWA communication system according to the present invention.

Referring to FIG. 9, the source RS relays data between the MS and the BS, while acting as a serving node for the MS in step 911. In step 913, the source RS monitors reception of a handover complete message having the configuration of Table 1 from the BS. If the handover complete message has not been received, the source RS returns to step 911 in which it relays data between the MS and the BS as a serving node of the MS.

However, upon receipt of the handover complete message from the BS, the source RS deletes information about the MS in step 915 and ends the algorithm of the present invention.

As described above, the present invention defines a handover complete message indicating to a source node that an MS has moved to a target node and completes network reentry to the target node, thereby completing a handover procedure in a multi-hop relay system where a multi-hop relay path is provided between an MS and a BS by use of an RS. Therefore, the RS or the BS can facilitate management of information about the MS and resources. The handover complete message can be used as an indication instructing the source node to delete information about the MS that is now ready to normally communicate with the target node.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of a Base Station (BS) for processing a handover complete signal in a multi-hop relay wireless communication system, comprising:
detecting a source node of a Mobile Station (MS), when the MS completes network reentry to the BS; and
transmitting a handover complete message for the MS to the source node.

2. The method of claim 1, wherein the transmission further comprises:
determining whether the source node preserves information about the MS, if the source node is a Relay Station (RS) within a cell where the MS is located; and
transmitting the handover complete message for the MS to the source node, if the source node preserves the MS information.

3. The method of claim 1, wherein the transmission further comprises:
determining whether the BS has information about the source node, if the source node is not an RS within a cell where the MS is located;
generating the handover complete message for the MS and transmitting the handover complete message to the source node, if the BS has the information about the source node; and
generating the handover complete message for the MS and broadcasting the handover complete message to a backbone network, if the BS does not have the information about the source node.

4. A method of a Base Station (BS) for processing a handover complete signal in a multi-hop relay wireless communication system, comprising:
determining, upon receipt of a handover complete message for a Mobile Station (MS) that has completed a handover, whether the handover complete message is from a neighbor BS;
deleting information about the MS, if the handover complete message is from the neighbor BS; and
preserving the MS information, if the handover complete message is not from the neighbor BS.

5. The method of claim 4, wherein the deleting further comprises:
determining whether a source node of the MS is the BS, if the handover complete message is from the neighbor BS;
deleting the MS information if the source node of the MS is the BS; and
transmitting the handover complete message to a Relay Station (RS) managed by the BS and deleting the MS information, if the source node of the MS is the RS.

6. The method of claim 5, wherein the transmitting and deleting further comprises:
determining whether the RS preserves the MS information, if the source node is the RS;
transmitting the handover complete message to the RS and deleting the MS information if the RS preserves the MS information; and
deleting the MS information if the RS does not preserve the MS information

7. The method of claim 4, wherein the preserving further comprises:
determining whether a source node of the MS is an RS managed by the BS, if the handover complete message is not from the neighbor BS;
transmitting the handover complete message to the source node and preserving the MS information, if the source node is the RS managed by the BS; and
preserving the MS information, if the source node is the BS.

8. The method of claim 7, wherein the transmitting and preserving further comprises:
determining whether the RS preserves the MS information, if the source node is the RS managed by the BS;
transmitting the handover complete message to the RS and preserving the MS information if the RS preserves the MS information; and
preserving the MS information if the RS does not preserve the MS information.

9. The method of claim 7, further comprising:
determining whether the BS has information about the source node, if the source node is not either the BS or the RS managed by the BS;
transmitting the handover complete message to a BS of the source node, if the BS has information about the source node; and
broadcasting the handover complete message to a backbone network, if the BS does not have the information about the source node.

10. A method of a Relay Station (RS) for processing a handover complete signal in a multi-hop relay wireless communication system, comprising:
generating a handover complete message for a Mobile Station (MS), when the MS completes network reentry to the RS; and
transmitting the handover complete message to a Base Station (BS).

11. A method of a Relay Station (RS) for processing a handover complete signal in a multi-hop relay wireless communication system, comprising:
determining whether the RS has determined to preserve information about a Mobile Station (MS), upon receipt of a handover indication message from the MS; and
preserving the MS information for an MS information preservation time period, if the RS has determined to preserve the MS information.

12. The method of claim 11, further comprising deleting the MS information, when the MS information preservation time period expires.

13. The method of claim 11, further comprising:
determining whether a handover complete message for the MS has been received from a Base Station (BS) during the MS information preservation time period; and
deleting the MS information, upon receipt of the handover complete message from the BS.

14. The method of claim 11, further comprising deleting the MS information, if the RS has determined not to preserve the MS information.

15. An apparatus for processing a handover complete signal in a multi-hop relay wireless communication system, comprising:
a Base Station (BS) for transmitting, when a Mobile Station (MS) completes network reentry to the BS, a handover complete message for the MS to at least one of a source node of the MS or a BS of the source node, deleting, upon receipt of a handover complete message from a neighbor BS, information about an MS that has completed a handover associated with the handover complete message, and preserving, upon receipt of a handover complete message from a Relay Station (RS) managed by the BS, information about an MS that has completed a handover associated with the handover complete message; and
an RS for generating a handover complete message and transmitting the handover complete message to a BS, if the MS completes network reentry to the RS, and upon receipt of a handover indication message from an MS, checking whether the RS has determined to preserve information about the MS and preserving the MS information for an MS information preservation time period, if the RS has determined to preserve the MS information.

16. The apparatus of claim 15, wherein the RS deletes the MS information upon receipt of a handover complete message during the MS information preservation time period.

17. A method of a Relay Station (RS) for processing a handover complete signal in a multi-hop relay wireless communication system, comprising:
relaying data between a Mobile Station (MS) and a Base Station (BS); and
deleting information about the MS, upon receipt of a handover complete message for the MS from the BS.

18. An apparatus for processing a handover complete signal in a multi-hop relay wireless communication system, comprising:
a Base Station (BS) for transmitting, when a Mobile Station (MS) completes network reentry to the BS, a handover complete message for the MS to at least one of a source node of the MS and a BS of the source node, and upon receipt of a handover complete message from a neighbor BS, deleting information about an MS that has completed a handover associated with the handover complete message; and
a Relay Station (RS) for relaying data between an MS and the BS and deleting information about the MS, upon receipt of a handover complete message for the MS from the BS.

19. The apparatus of claim 18, wherein upon receipt of a handover complete message for an MS from a neighbor BS, the BS determines whether a source node of the MS is an RS managed by the BS and transmits a handover complete message to the RS, if the RS preserves information about the MS.

20. A method of a Base Station (BS) for processing a handover complete signal in a multi-hop relay wireless communication system, comprising:
detecting completion of network reentry of a Mobile Station (MS); and
transmitting a handover complete message for the MS to a source node of the MS.

21. A Base Station (BS) for processing a handover complete signal in a multi-hop relay wireless communication system, comprising:
means for detecting completion of network reentry of a Mobile Station (MS); and
means for transmitting a handover complete message for the MS to a source node of the MS.

22. A Relay Station (RS) for processing a handover complete signal in a multi-hop relay wireless communication system, comprising:
means for generating a handover complete message for a Mobile Station (MS), when the MS completes network reentry to the RS; and
means for transmitting the handover complete message to a Base Station (BS).

23. A method of a Base Station (BS) for processing a handover complete signal in a multi-hop relay wireless communication system, comprising:
determining, upon receipt of a handover complete message for a Mobile Station (MS) that has completed a handover, whether the handover complete message is from a neighbor BS; and
deleting information about the MS, if the handover complete message is from the neighbor BS.
